SEQUENCE LISTING (7 sequences)

SEQ ID NO: 1 - protein, 524 aa, Paenibacillus polymyxa
VVHGQTAKTITIKVDTFKDRKPISPYIYGTNQDLAGDENMAARRLGGNRMTGYNWENNMSNAGSDWQQSSDNYLCSNGGLTQAECEKPGAVTTSFHDQSLKLGTYSLVTLPMAGYVAKDGNGSVQESEKAPSARWNQVVNAKNAPFQLQPDLNDNRVYVDEFVHFLVNKYGTASTKAGVKGYALDNEPALWSHTHPRIHGEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWNSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 2 - protein, 524 aa, Paenibacillus polymyxa
VVHGQTAKTITIKVDTFKDRKPISPYIYGTNQDLAGDENMAARRLGGNRMTGYNWENNMSNAGSDWQHSSDNYLCSNGGLTQAECEKPGAVVTSFHDQSLKLGTYSLVTLPMAGYVAADGNGSVQESEAAPSARWNQVVNAKNAPFQLQPDLNDNYVYVDEFVHFLVNKYGTASTKAGVKGYALDNEPALWSHTHPRIHPEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 3 - protein, 524 aa, Paenibacillus polymyxa
VVHGQTAKTITIKVDTFKDRKPISPYIYGTNQDLAGDENMAARRLGGNRMTGYNWENNMSNAGSDWQHSSDNYLCSNGGLTQAECEKPGAVVTSFHDQSLKLGTYSLVTLPMAGYVAADGNGSVQESETAPSARWNQVVNAKNAPFQLQPDLNDNYVYVDEFVHFLVNKYGTASTKAGVKGYALDNEPALWSHTHPRIHPEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 4 - protein, 524 aa, Paenibacillus polymyxa
VVHGQTAKTITIKVDTFKDRKPISPYIYGTNQDLAGDENMAARRLGGNRMTGYNWENNMSNAGSDWQHSSDNYLCSNGGLTQEECEKPGAVVTSFHDQSLKLGTYSLVTLQMAGYVAADGNGPVQESETAPSARWNQVVNAKNAPFQLQPDLNDNYVYMDEFVHFLVNKYGTASTKAGVKGYALDNEPALWSHTHPRIHPEKVGAKELVDRSVSLSKAVKAIDAGAEVFGPVLYGFGAYKDLQTAPDWDSVKGNYEWFVDYYLDQMRLSSQVEGKRLLDVFDVHWYPEAMGGGERITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 5 - protein, 524 aa, Paenibacillus polymyxa
VVHGQTAKTITIKVDTFKDRKPISPYIYGTNQDLAGDENMAARRLGGNRMTGYNWENNMSNAGSDWQHSSDNYLCSNGGLTEAECEKPGAVVTSFHDQSLKLGTYSLVTLQMAGYVAADGNGPVQESETAPSARWNKVVNAKNAPFQLQPDLNDNYVYMDEFVHFLVNKYGTASTKAGVKGYALDNEPALWSHTHPRIHPEKTGAKELVHRSVSLSKAVKAIDAGAEVFGPVLYGFMAYKDLQTAPDWDSVKGNYEWFVDYYLDQMRLSSQVEGKRLLDVFDVHWYPEAMGGGERITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 6 - protein, 524 aa, Paenibacillus polymyxa
VVHGQTAKTITIKVDTFKDRKPISPYIYGTNQDLAGDENMAARRLGGNRMTGYNWENNMSNAGSDWQHSSDNYLCSNGGLTQEECEKPGAVVTSFHDQSLKLGTYSLVTLQMAGYVAADGNGPVQESETAPSARWNKVVNAKNAPFKLQPDLNDNYVYMDEFVHFLVNKYGTASTKAGVKGYAMDNEPALWSHTHPRIHPEKVGAKELVHRSVSLSKAVKAIDAGAEVFGPVLYGFGAYFDLQTAPDWDSEKGNYQWFVDYYLDQMRLSSEVEGKRLLDVFDVHWYPEAMGGGERITNEVGNDETKKARMQAPRTLWDPTYKEDSWIAEWFSEFLPILPRLKQSVDKYYPGTKLAMTEYSYGGENDISGGIAMTDVLGILGKNDVYMANYWKLKDGVNNYVQAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 7 - protein, 514 aa, Paenibacillus polymyxa
QTAKTITIKVDTFKDRKPISPYIYGTNQDLAGDENMAARRLGGNRMTGYNWENNMSNAGSDWQHSSDNYLCSNGGLTQEECEKPGAVVTSFHDQSLKLGTYSLVTLQMAGYVAADGNGPVQESETAPSARWNQVVNAKNAPFQLQPDLNDNYVYMDEFVHFLVNKYGTASTKAGVKGYALDNEPALWSHTHPRIHPEKVGAKELVDRSVSLSKAVKAIDAGAEVFGPVLYGFGAYKDLQTAPDWDSVKGNYEWFVDYYLDQMRLSSQVEGKRLLDVFDVHWYPEAMGGGERITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTG

(19) United States
(12) Patent Application Publication
(10) Pub. No.: US 2025/0145912 A1
(43) Pub. Date: May 8, 2025

(54) DETERGENT COMPOSITIONS CONTAINING A XYLOGLUCANASE AND A HUEING DYE

(71) Applicant: The Procter & Gamble Company, Cincinnati, OH (US)

(72) Inventors: Patrick Christopher STENGER, Fairfield, OH (US); Melanie Beth GROSSE, Villa Hills, KY (US)

(21) Appl. No.: 18/501,324

(22) Filed: Nov. 3, 2023

(51) Int. Cl. C11D 3/386; C09B 46/00; C11D 1/22; C11D 1/29; C11D 1/37; C11D 3/40

(52) U.S. Cl. CPC C11D 3/38636; C09B 46/00; C11D 1/22; C11D 1/29; C11D 1/37; C11D 3/38618; C11D 3/40; C12Y 302/01151; C11D 2111/12

(57) ABSTRACT

The present invention relates generally to detergent compositions and, more specifically, to detergent compositions containing a hueing dye and a xyloglucanase.

### TECHNICAL FIELD

The present invention relates generally to detergent compositions and, more specifically, to detergent compositions containing a hueing dye, and a xyloglucanase.

### REFERENCE TO AN ELECTRONIC SEQUENCE LISTING

The contents of the electronic sequence listing (16631_sequence_listing.xml; Size: 10,481 bytes; and Date of Creation: Nov. 1, 2023) is herein incorporated by reference in its entirety.

### BACKGROUND

There is a continuous desire to provide laundry detergent compositions that are stable, deliver good cleaning and prevent whiteness loss.

Optical brighteners are used in laundry detergent compositions to provide a visual benefit when deposited on fabrics as they may make white fabrics look whiter and/or make colored fabrics appear brighter. Optical brighteners used which are more insoluble in water are preferable for deposition on fabrics. However, such brighteners are characteristically more difficult to stably formulate in aqueous liquid laundry compositions. Certain counterions and surfactant systems can be preferred to stably formulate brighteners in liquid laundry compositions, these can add additional cost to the formulation or require additional constraints on the choice of surfactant systems. Additionally, there can be incompatibilities between dye transfer inhibitors and brighteners leading to reduction in the brightener or dye transfer benefit. Therefore, alternative whiteness technologies that are not impacted by dye transfer inhibitors are desirable.

High level of brightener can under certain circumstances stain fabrics limiting the benefit profile that these technologies can deliver. Furthermore, the benefit of optical brighteners is limited to UV light conditions, which is generally outdoors.

It would be desirable to formulate laundry detergents without these constraints that provide improved whiteness.

### SUMMARY

The present invention relates to a laundry detergent composition comprising:
a) from 0.0001% to 1% by weight of the composition of a hueing dye;
b) a xyloglucanase; and
wherein the composition is substantially free of optical brightener and optionally but preferably substantially free of borate.

The present invention further relates to methods of laundering fabric using the detergent composition of the invention and the use of the laundry detergent composition for the laundering of white fabrics to prevent whiteness loss.

### DETAILED DESCRIPTION

Features and benefits of the present invention will become apparent from the following description, which includes examples intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, the articles including “the,” “a” and “an” when used in a claim or in the specification, are understood to mean one or more of what is claimed or described.

As used herein, the terms “include,” “includes” and “including” are meant to be non-limiting.

As used herein, the term “gallon” refers to a “US gallon.”

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, 0.25%, 0.1%, 0.05%, or 0.01%, or even 0%, by weight of the composition, of the component.

As used herein, the term “soiled material” is used non-specifically and may refer to any type of flexible material consisting of a network of natural or artificial fibers, including natural, artificial, and synthetic fibers, such as, but not limited to, cotton, linen, wool, polyester, nylon, silk, acrylic, and the like, as well as various blends and combinations. Soiled material may further refer to any type of hard surface, including natural, artificial, or synthetic surfaces, such as, but not limited to, tile, granite, grout, glass, composite, vinyl, hardwood, metal, cooking surfaces, plastic, and the like, as well as blends and combinations.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All cited patents and other documents are, in relevant part, incorporated by reference as if fully restated herein. The citation of any patent or other document is not an admission that the cited patent or other document is prior art with respect to the present invention.

In this description, all concentrations and ratios are on a weight basis of the detergent composition unless otherwise specified.

### Detergent Composition

As used herein the phrase “detergent composition” or “cleaning composition” includes compositions and formulations designed for cleaning soiled material. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation. The detergent compositions may have a form selected from liquid, powder, single-phase or multi-phase unit dose, pouch, tablet, gel, paste, bar, or flake. Preferably, the detergent composition of the invention is a laundry detergent composition.

### Laundry Detergent Composition:

The laundry detergent composition can be in any suitable form, such as liquid, paste, granular, solid, powder, or in conjunction with a carrier such as a substrate. Preferred laundry detergent compositions are either liquid or granular, with liquid being most preferred.

As used herein, “liquid detergent composition” refers to liquid detergent composition which is fluid, and preferably capable of wetting and cleaning a fabric, e.g., clothing in a domestic washing machine. As used herein, “laundry detergent composition” refers to compositions suitable for washing clothes. The composition can include solids or gases in suitably subdivided form, but the overall composition excludes product forms which are non-fluid overall, such as tablets or granules. The liquid laundry detergent composition preferably has a density in the range from 0.9 to 1.3 grams per cubic centimeter, more specifically from 1.00 to 1.10 grams per cubic centimeter, excluding any solid additives but including any bubbles, if present.

Aqueous liquid laundry detergent compositions are preferred. For such aqueous liquid laundry detergent compositions, the water content can be present at a level of from 5% to 99%, preferably from 15% to 90%, more preferably from 25% to 80% by weight of the liquid detergent composition.

The pH range of the detergent composition is preferably from 7.5 to 9.5, preferably from pH 8 to 9. It has been found that the presence of borate in the composition of the invention can give rise to stability issues at high pH. The composition of the invention presents flexibility in formulation when they are substantially free of borate.

The detergent composition can also be encapsulated in a water soluble film, to form a unit dose article. Such unit dose articles comprise a detergent composition of the present invention, wherein the detergent composition comprises less than 20%, preferably less than 15%, more preferably less than 10% by weight of water, and the detergent composition is enclosed in a water-soluble or dispersible film. Such unit-dose articles can be formed using any means known in the art.

Suitable water soluble pouch materials include polymers, copolymers or derivatives thereof. Preferred polymers, copolymers or derivatives thereof can be selected from the group consisting of: polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof.

### Hueing Dye

The hueing dye (sometimes referred to as bluing or shading dyes) typically provides a blue or violet shade to fabric. Hueing dyes can be used either alone or in combination to create a specific shade of hueing and/or to shade different fabric types. This may be provided for example by mixing a red and green-blue dye to yield a blue or violet shade. The fabric hueing dye may be selected from any chemical class of dye as known in the art, including but not limited to acridine, anthraquinone (including polycyclic quinones), azine (including oxazine and thiazine), azo (e.g., monoazo, disazo, trisazo, tetrakisazo, polyazo), benzodifurane, benzodifuranone, carotenoid, coumarin, cyanine, diazahemicyanine, diphenylmethane, formazan, hemicyanine, indigoids, methane, naphthalimides, naphthoquinone, nitro, nitroso, phthalocyanine, pyrazoles, stilbene, styryl, triarylmethane (including triphenylmethane and xanthenes), and mixtures thereof.

Suitable hueing dyes include small molecule dyes, polymeric dyes and dye-clay conjugates. Preferred hueing dyes are selected from small molecule dyes and polymeric dyes, more preferably the hueing dye is a polymeric dye.

### Small Molecule Dyes

Suitable small molecule dyes may be selected from the group consisting of dyes falling into the Colour Index (C.I., Society of Dyers and Colourists, Bradford, UK) classifications of Acid, Direct, Basic, Reactive, Solvent or Disperse dyes. Preferably such dyes can be classified as Blue, Violet, Red, Green or Black, and provide the desired shade either alone or in combination with other dyes or in combination with other adjunct ingredients. Reactive dyes may contain small amounts of hydrolyzed dye as sourced, and in detergent formulations or in the wash may undergo additional hydrolysis. Such hydrolyzed dyes and mixtures may also serve as suitable small molecule dyes.

In another aspect, suitable dyes include those selected from the group consisting of dyes denoted by the Colour Index designations such as Direct Violet 5, 7, 9, 11, 31, 35, 48, 51, 66, and 99, Direct Blue 1, 71, 80 and 279, Acid Red 17, 73, 52, 88 and 150, Acid Violet 15, 17, 24, 43, 49 and 50, Acid Blue 15, 17, 25, 29, 40, 45, 48, 75, 80, 83, 90 and 113, Acid Black 1, Basic Violet 1, 3, 4, 10 and 35, Basic Blue 3, 16, 22, 47, 66, 75 and 159, anthraquinone Disperse or Solvent dyes such as Solvent Violet 11, 13, 14, 15, 15, 26, 28, 29, 30, 31, 32, 33, 34, 26, 37, 38, 40, 41, 42, 45, 48, 59; Solvent Blue 11, 12, 13, 14, 15, 17, 18, 19, 20, 21, 22, 35, 36, 40, 41, 45, 59, 59:1, 63, 65, 68, 69, 78, 90; Disperse Violet 1, 4, 8, 11, 11:1, 14, 15, 17, 22, 26, 27, 28, 29, 34, 35, 36, 38, 41, 44, 46, 47, 51, 56, 57, 59, 60, 61, 62, 64, 65, 67, 68, 70, 71, 72, 78, 79, 81, 83, 84, 85, 87, 89, 105; Disperse Blue 2, 3, 3:2, 8, 9, 13, 13:1, 14, 16, 17, 18, 19, 22, 23, 24, 26, 27, 28, 31, 32, 34, 35, 40, 45, 52, 53, 54, 55, 56, 60, 61, 62, 64, 65, 68, 70, 72, 73, 76, 77, 80, 81, 83, 84, 86, 87, 89, 91, 93, 95, 97, 98, 103, 104, 105, 107, 108, 109, 11, 112, 113, 114, 115, 116, 117, 118, 119, 123, 126, 127, 131, 132, 134, 136, 140, 141, 144, 145, 147, 150, 151, 152, 153, 154, 155, 156, 158, 159, 160, 161, 162, 163, 164, 166, 167, 168, 169, 170, 176, 179, 180, 180:1, 181, 182, 184, 185, 190, 191, 192, 196, 197, 198, 199, 203,204,213, 214,215, 216,217,218, 223,226,227, 228,229,230, 231,232, 234, 235, 236, 237, 238, 239, 240, 241, 242, 243, 244, 245, 246, 247, 249, 252, 261, 262, 263, 271, 272, 273, 274, 275, 276, 277, 289, 282, 288, 289, 292, 293, 296, 297, 298, 299, 300, 302, 306, 307, 308, 309, 310, 311, 312, 314, 318, 320, 323, 325, 326, 327, 331, 332, 334, 347, 350, 359, 361, 363, 372, 377 and 379, azo Disperse dyes such as Disperse Blue 10, 11, 12, 21, 30, 33, 36, 38, 42, 43, 44,47,79,79:1,79:2,79:3, 82, 85, 88, 90, 94, 96, 100, 101, 102, 106, 106:1, 121, 122, 124, 125, 128, 130, 133, 137, 138, 139, 142, 146, 148, 149, 165, 165:1, 165:2, 165:3, 171, 173, 174, 175, 177, 183, 187, 189, 193, 194,200,201,202,206,207,209,210,211,212,219,220,224,225,248,252, 253, 254, 255, 256, 257, 258, 259, 260, 264, 265, 266, 267, 268, 269, 270, 278, 279, 281, 283, 284, 285, 286, 287, 290, 291, 294, 295, 301, 304, 313, 315, 316, 317:319, 321, 322, 324, 328, 330, 333, 335, 336, 337, 338, 339, 340, 341, 342, 343, 344, 345, 346, 351, 352, 353, 355, 356, 358, 360, 366, 367, 368, 369, 371, 373, 374, 375, 376 and 378, Disperse Violet 2, 3, 5, 6, 7, 9, 10, 12, 3, 16, 24, 25,33,39, 42, 43, 45, 48, 49, 50, 53, 54, 55, 58, 60, 63, 66, 69, 75, 76, 77, 82, 86, 88, 91, 92, 93, 93:1, 94, 95, 96, 97, 98, 99, 100, 102, 104, 106 and 107. Preferably, small molecule dyes can be selected from the group consisting of C. I. numbers Acid Violet 17, Acid Blue 80, Acid Violet 50, Direct Blue 71, Direct Violet 51, Direct Blue 1, Acid Red 88, Acid Red 150, Acid Blue 29, Acid Blue 113 or mixtures thereof.

In another aspect, suitable small molecule dyes include dyes with CAS-No's 52583-54-7, 42783-06-2, 210758-04-6, 104366-25-8, 122063-39-2, 167940-11-6,52239-04-0, 105076-77-5,84425-43-4, and 87606-56-2, and non-azo dyes Disperse Blue 250, 354, 364, Solvent Violet 8, Solvent Blue 43, 57, Lumogen F Blau 650, and Lumogen F Violet 570.

In another aspect, suitable small molecule dyes include azo dyes, preferably mono-azo dyes, covalently bound to phthalocyanine moieties, preferably Al- and Si-phthalocyanine moieties, via an organic linking moiety.

### Polymeric Dyes

Suitable polymeric dyes include dyes selected from the group consisting of polymers containing covalently bound (sometimes referred to as conjugated) chromogens, (also known as dye-polymer conjugates), for example polymers with chromogen monomers co-polymerized into the backbone of the polymer and mixtures thereof.

Polymeric dyes include: (a) Reactive dyes bound to water soluble polyester polymers via at least one and preferably two free OH groups on the water soluble polyester polymer. The water soluble polyester polymers can be comprised of comonomers of a phenyl dicarboxylate, an oxyalkyleneoxy and a polyoxyalkyleneoxy; (b) Reactive dyes bound to polyamines which are polyalkylamines that are generally linear or branched. The amines in the polymer may be primary, secondary and/or tertiary. Polyethyleneimine in one aspect is preferred. In another aspect, the polyamines are ethoxylated; (c) Dye polymers having dye moieties carrying negatively charged groups obtainable by copolymerization of an alkene bound to a dye containing an anionic group and one or more further alkene comonomers not bound to a dye moiety; (d) Dye polymers having dye moieties carrying positively charged groups obtainable by copolymerization of an alkene bound to a dye containing an cationic group and one or more further alkene comonomers not bound to a dye moiety; (e) Polymeric azo polyoxyalkylene dyes containing carboxylate groups; in some aspects those having carboxylic acid groups with a pKa value below 4, or below 3, or even below 2, may be preferred; and (f) dye polymer conjugates comprising at least one reactive dye and a polymer comprising a moiety selected from the group consisting of a hydroxyl moiety, a primary amine moiety, a secondary amine moiety, a thiol moiety and combinations thereof; said polymers preferably selected from the group consisting of polysaccharides, proteins, polyalkyleneimines, polyamides, polyols, and silicones. In one aspect, carboxymethyl cellulose (CMC) may be covalently bound to one or more reactive blue, reactive violet or reactive red dye such as CMC conjugated with C.I. Reactive Blue 19, sold by Megazyme, Wicklow, Ireland under the product name AZO-CM-CELLULOSE, product code S-ACMC,

Other suitable polymeric dyes include polymeric dyes selected from the group consisting of alkoxylated triphenyl-methane polymeric colorants, alkoxylated carbocyclic and alkoxylated heterocyclic azo colorants, including alkoxylated thiophene polymeric colorants, and mixtures thereof. Preferred polymeric dyes comprise the optionally substituted alkoxylated dyes, such as alkoxylated triphenyl-methane polymeric colorants, alkoxylated carbocyclic and alkoxylated heterocyclic azo colorants including alkoxylated thiophene polymeric colorants, and mixtures thereof, such as the fabric-substantive colorants sold under the name of Liquitint® (Milliken, Spartanburg, South Carolina, USA).

Suitable polymeric bluing dyes are illustrated below. As with all such alkoxylated compounds, the organic synthesis may produce a mixture of molecules having different degrees of alkoxylation. During a typical ethoxylation process, for example, the randomness of the ethylene oxide addition results in a mixture of oligomers with different degrees of ethoxylation. As a consequence of its ethylene oxide number distribution, which often follows a Poisson law, a commercial material contains substances with somewhat different properties. For example, in one aspect the product resulting from an ethoxylation is not a single compound containing five (CH₂CH₂O) units as the general structure (Formula A below, with x+y=5) may suggest. Instead, the product is a mixture of several homologs whose total of ethylene oxide units varies from about 2 to about 10. Industrially relevant processes will typically result in such mixtures, which may normally be used directly to provide the fabric shading dye, or less commonly may undergo a purification step.

Preferably, the hueing dye has the following structure:

Dye-(G)ₐ-NR¹R²,

wherein the -(G)ₐ-NR¹R² group is attached to an aromatic ring of the dye, G is independently —SO₂— or —C(O)—, which may be derived from an —SO₃H or —CO₂H residue of the Dye, the index a is an integer with a value of 0 or land R¹ and R² are independently selected from H, a polyoxyalkylene chain, C₁₋₈ cycloalkyl, C₁₋₈ alkyl, C₇₋₁₆ alkaryl, the cycloalkyl, alkyl and alkaryl groups may comprise ether (C—O—C), ester (includes —C(O)O— and —OC(O)O—) and/or amide (includes —C(O)NH— and —C(O)NR³— wherein R³ is C₁₋₄ alkyl) links, one or two pair of hydrogen atoms on adjacent carbons may be removed to form carbon-carbon double or triple bonds, the alkyl chains may be substituted with —Cl, —Br, —CN, —OH, a polyoxyalkylene chain, and mixtures thereof; C₆₋₁₀ aryl, optionally substituted with a polyoxyalkylene chain, and mixtures thereof; said polyoxyalkylene chains independently having from about 2 to about 100, about 2 to about 50, about 3 to about 30 or about 4 to about 20 repeating units. Preferably, the repeating units are selected from the group consisting of ethylene oxide, propylene oxide, butylene oxide and mixtures thereof. Preferably, the repeating units are essentially ethylene oxide.

Preferably, the hueing dye may have the structure of Formula A:

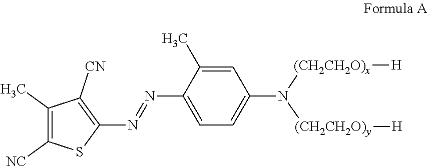

wherein the index values x and y are independently selected from 1 to 10. The hueing dye may have expected variations to the general structure as shown below:

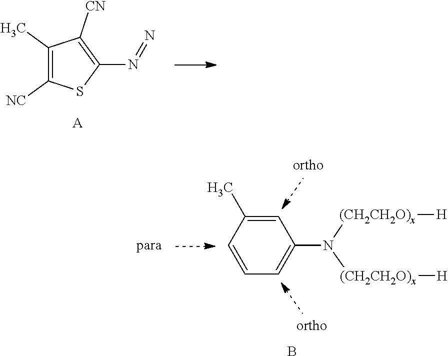

wherein moiety A shown above is attached via the distal nitrogen atom (see arrow) to one of the three sites on the aromatic ring of moiety B indicated by the dashed arrows shown above. Preferably said A moiety is attached at the position on the aryl ring para to the N substituent on moiety B, which typically is the predominant point of attachment in such azo coupling reactions. However the A moiety may be attached at either of the other two indicated positions that are located ortho to the N substituent on moiety B; said attachment typically constitutes a minor side product in such azo coupling reactions and the skilled artisan recognizes such material may be present in minor amounts along with the predominant para-isomer. Two typical products resulting from this coupling are illustrated below, one at the para position and another at one of the two possible ortho positions. Such mixtures are normally used without further purification.

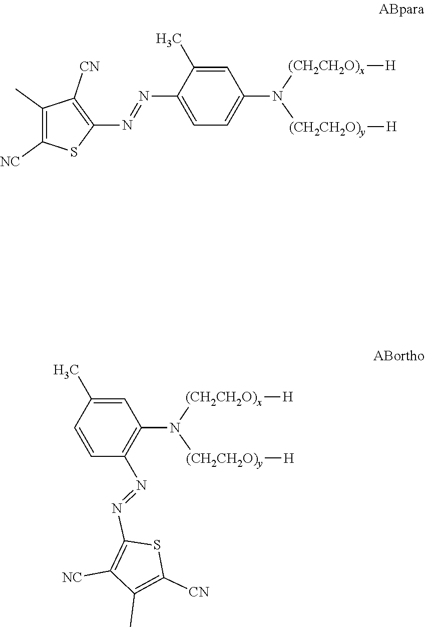

The index values x and y in moiety B above are independently selected from 1 to 10. In some aspects, the average degree of ethoxylation, x+y, sometimes also referred to as the average number of ethoxylate groups, is from about 3 to about 12, preferably from about 4 to about 8. In some embodiments the average degree of ethoxylation, x+y, can be from about 5 to about 6.

The range of ethoxylation present in the mixture varies depending on the average number of ethoxylates incorporated. Typical distributions for ethoxylation of toluidine with either 5 or 8 ethoxylates are shown in Table II on page 42 in the Journal of Chromatography A 1989, volume 462, pp. 39-47. The hueing dyes are synthesized according to the procedures disclosed in U.S. Pat. No. 4,912,203 to Kluger et al.; a primary aromatic amine is reacted with an appropriate amount of ethylene oxide, according to procedures well known in the art. The polyethyleneoxy substituted m-toluidine useful in the preparation of the colorant can be prepared by a number of well known methods. It is preferred, however, that the polyethyleneoxy groups be introduced into the m-toluidine molecule by reaction of the m-toluidine with ethylene oxide. Generally the reaction proceeds in two steps, the first being the formation of the corresponding N,N-dihydroxyethyl substituted m-toluidine. In some aspects, no catalyst is utilized in this first step (for example as disclosed at Column 4, lines 16-25 of U.S. Pat. No. 3,927,044 to Foster et al.). The dihydroxyethyl substituted m-toluidine is then reacted with additional ethylene oxide in the presence of a catalyst such as sodium (described in Preparation II of U.S. Pat. No. 3,157,633 to Kuhn), or it may be reacted with additional ethylene oxide in the presence of sodium or potassium hydroxide (described in Example 5 of U.S. Pat. No. 5,071,440 to Hines et al.). The amount of ethylene oxide added to the reaction mixture determines the number of ethyleneoxy groups which ultimately attach to the nitrogen atom.

In some aspects, it may be advantageous to dissolve the hueing dye in a solvent which may be protic or aprotic. Typically for ease of handling and formulation such hueing dyes may be dissolved in polar protic solvents such as, for example, a low molecular weight polyethyleneglycol such as PEG200. In some aspects, an excess of a polyethyleneoxy substituted coupler, such as a m-toluidine coupler, may be employed in the formation of the hueing dye and remain as a component in the final colorant mixture. In certain aspects, the presence of excess coupler or diluting solvent may confer advantageous properties to a mixture in which it is incorporated such as the raw material, a pre-mix, a finished product or even the wash solution prepared from the finished product.

### Dye-Clay Conjugates

Suitable dye clay conjugates include dye clay conjugates selected from the group comprising at least one cationic/basic dye and a smectite clay; a preferred clay may be selected from the group consisting of Montmorillonite clay, Hectorite clay, Saponite clay and mixtures thereof. In another aspect, suitable dye clay conjugates include dye clay conjugates selected from the group consisting of a clay and one cationic/basic dye selected from the group consisting of C.I. Basic Yellow 1 through 108, C.I. Basic Orange 1 through 69, C.I. Basic Red 1 through 118, C.I. Basic Violet 1 through 51, C.I. Basic Blue 1 through 164, C.I. Basic Green 1 through 14, C.I. Basic Brown 1 through 23, CI Basic Black 1 through 11 In still another aspect, suitable dye clay conjugates include dye clay conjugates selected from the group consisting of: Montmorillonite Basic Blue B7 C.I. 42595 conjugate, Montmorillonite Basic Blue B9 C.I. 52015 conjugate, Montmorillonite Basic Violet V3 C.I. 42555 conjugate, Montmorillonite Basic Green G1 C.I. 42040 conjugate, Montmorillonite Basic Red R1 C.I. 45160 conjugate, Montmorillonite C.I. Basic Black 2 conjugate, Hectorite Basic Blue B7 C.I. 42595 conjugate, Hectorite Basic Blue B9 C.I. 52015 conjugate, Hectorite Basic Violet V3 C.I. 42555 conjugate, Hectorite Basic Green G1 C.I. 42040 conjugate, Hectorite Basic Red R1 C.I. 45160 conjugate, Hectorite C.I. Basic Black 2 conjugate, Saponite Basic Blue B7 C.I. 42595 conjugate, Saponite Basic Blue B9 C.I. 52015 conjugate, Saponite Basic Violet V3 C.I. 42555 conjugate, Saponite Basic Green G1 C.I. 42040 conjugate, Saponite Basic Red R1 C.I. 45160 conjugate, Saponite C.I. Basic Black 2 conjugate and mixtures thereof.

### Pigments

Suitable pigments include pigments selected from the group consisting of flavanthrone, indanthrone, chlorinated indanthrone containing from 1 to 4 chlorine atoms, pyranthrone, dichloropyranthrone, monobromodichloropyranthrone, dibromodichloropyranthrone, tetrabromopyranthrone, perylene-3,4,9,10-tetracarboxylic acid diimide, wherein the imide groups may be unsubstituted or substituted by C1-C3-alkyl or a phenyl or heterocyclic radical, and wherein the phenyl and heterocyclic radicals may additionally carry substituents, anthrapyrimidinecarboxylic acid amides, violanthrone, isoviolanthrone, dioxazine pigments, copper phthalocyanine which may contain up to 2 chlorine atoms per molecule, polychloro-copper phthalocyanine or polybromochloro-copper phthalocyanine containing up to 14 bromine atoms per molecule and mixtures thereof. Other suitable pigments are described in WO2008/090091. In another aspect, suitable pigments include pigments selected from the group consisting of Ultramarine Blue (C.I. Pigment Blue 29), Ultramarine Violet (C.I. Pigment Violet 15), Monastral Blue and mixtures thereof. Particularly preferred are Pigment Blues 15 to 20, especially Pigment Blue 15 and/or 16. Other suitable pigments include those selected from the group consisting of Ultramarine Blue (C.I. Pigment Blue 29), Ultramarine Violet (C.I. Pigment Violet 15), Monastral Blue and mixtures thereof.

The total amount of hueing dye in the cleaning composition of the invention is typically from 0.0001 to 0.25 wt % based on the total cleaning composition, preferably from 0.001 to 0.10 wt %, most preferably from 0.005 to 0.05 wt %. Based on the wash liquor, the concentration of hueing dye typically is from 1 ppb to 5 ppm, preferably from 10 ppb to 500 ppb. Of course, this will depend on the equivalent weights of the hueing dyes employed. Adjustments to levels may be required depending on the number of chromophores attached to a polymer of high molecular weight, for example, which may give rise to hueing dyes with very high equivalent weight values. One of ordinary skill in the art knows how to adjust the cited ranges depending on the hueing dyes used. The ranges of the total amount of hueing dyes given above are based on hueing dyes with equivalent weights of approximately 500 g/equivalent.

### Detersive Surfactants

Detersive surfactant as used herein means surfactants or mixtures of surfactants that provide cleaning, stain removing, or laundering benefit to soiled material. Suitable detersive surfactants can be: anionic surfactant, nonionic surfactant, zwitterionic surfactant, and combinations thereof. The detersive surfactant comprises a combination of anionic and nonionic surfactant.

The laundry composition can comprises detersive surfactant at a level of from 3 wt % to 50 wt %, preferably from 10 wt % to 37.5 wt %, more preferably from 15 wt % to 30 wt %.

Suitable anionic surfactants can be selected from the group consisting of: alkyl sulphates, alkyl ethoxy sulphates, alkyl sulphonates, alkyl benzene sulphonates, fatty acids and their salts, and mixtures thereof. However, by nature, every anionic surfactant known in the art of detergent compositions may be used, such as disclosed in “Surfactant Science Series”, Vol. 7, edited by W. M. Linfield, Marcel Dekker. However, the composition preferably comprises at least a sulphonic acid surfactant, such as a linear alkyl benzene sulphonic acid, but water-soluble salt forms may also be used. Alkyl ethoxy sulphates, or mixtures thereof, are also preferred.

Anionic sulfonate or sulfonic acid surfactants suitable for use herein include the acid and salt forms of linear or branched alkylbenzene sulfonates, alkyl ester sulfonates, alkane sulfonates, alkyl sulfonated polycarboxylic acids, and mixtures thereof. Suitable anionic sulfonate or sulfonic acid surfactants include: C5-C20 alkylbenzene sulfonates, more preferably C10-C16 alkylbenzene sulfonates, more preferably C11-C13 alkylbenzene sulfonates, C5-C20 alkyl ester sulfonates, C6-C22 primary or secondary alkane sulfonates, C5-C20 sulfonated polycarboxylic acids, and any mixtures thereof, but preferably C11-C13 alkylbenzene sulfonates. The aforementioned surfactants can vary widely in their 2-phenyl isomer content. Such sulfonate or sulfonic acid surfactants can be present at a level of from 1.0% to 20%, more preferably from 5.0% to 15%, and most preferably from 6.5 to 12.5% by weight of the composition.

Anionic sulphate salts suitable for use in the compositions of the invention include the primary and secondary alkyl sulphates, having a linear or branched alkyl or alkenyl moiety having from 9 to 22 carbon atoms or more preferably 12 to 18 carbon atoms. Also useful are beta-branched alkyl sulphate surfactants or mixtures of commercial available materials, having a weight average (of the surfactant or the mixture) branching degree of at least 50%.

Other suitable anionic surfactants for use herein include fatty methyl ester sulphonates and/or alkyl alkoxylated sulphates such as alkyl ethoxy sulphates (AES) and/or alkyl polyalkoxylated carboxylates (AEC). When used, the alkyl alkoxylated sulphate surfactant is preferably a blend of one or more alkyl ethoxylated sulphates. Suitable alkyl alkoxylated sulphates include C10-C18 alkyl ethoxylate, more preferably C12-C15 alkyl ethoxylate, with a degree of ethoxylation of from 1 to 5, preferably from 2 to 3. Preferably, the composition comprises the composition comprises from 0.01% to less than 3% by weight of the composition of an alkoxylated alkyl sulfate surfactant.

Suitable fatty acids include “natural” fatty acids, for example coconut, palm kernel, olive oil or tallow fatty acid and mixtures thereof. Such fatty acid surfactants can be present at a level of from 1.0% to 15%, more preferably from 2.0% to 12.5%, and most preferably from 5.0 to 10% by weight of the composition.

The anionic surfactants are typically present in the form of their salts with alkanolamines or alkali metals such as sodium and potassium.

The liquid detergent composition can comprise nonionic surfactant. The level of nonionic surfactant in the liquid detergent composition can be present at a level of from 1.0% to 20%, preferably from 2.5% to 15%, more preferably from 5.0% to 12.5% by weight of the composition.

Suitable nonionic surfactants include, but are not limited to C12-C18 alkyl ethoxylates (“AE”) including the so-called narrow peaked alkyl ethoxylates and C6-C12 alkyl phenol alkoxylates (especially ethoxylates and mixed ethoxy/propoxy), block alkylene oxide condensate of C6-C12 alkyl phenols, alkylene oxide condensates of C8-C22 alkanols and ethylene oxide/propylene oxide block polymers (Pluronic—BASF Corp.), as well as semi polar nonionics (e.g., amine oxides and phosphine oxides) can be used in the present compositions. An extensive disclosure of these types of surfactants is found in U.S. Pat. No. 3,929,678, Laughlin et al., issued Dec. 30, 1975.

Alkylpolysaccharides such as disclosed in U.S. Pat. No. 4,565,647 Llenado are also useful nonionic surfactants in the compositions of the invention.

Also suitable are alkyl polyglucoside surfactants.

Nonionic surfactants of use include those of the formula R₁(OC₂H₄)ₙOH, wherein R₁ is a C10-C16 alkyl group or a C8-C12 alkyl phenyl group, and n is from preferably 3 to 80. In some embodiments, the nonionic surfactants may be condensation products of C12-C15 alcohols with from 5 to 20 moles of ethylene oxide per mole of alcohol, e.g., C12-C13 alcohol condensed with 6.5 moles of ethylene oxide per mole of alcohol

Suitable amine oxide surfactants are amine oxides having the following formula: R₁R₂R₃NO wherein R₁ is an hydrocarbon chain comprising from 1 to 30 carbon atoms, preferably from 6 to 20, more preferably from 8 to 16 and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups. R₁ may be a saturated or unsaturated, substituted or unsubstituted linear or branched hydrocarbon chain.

Suitable amine oxides for use herein are for instance preferably C₁₂-C₁₄ dimethyl amine oxide, commercially available from Albright & Wilson, C₁₂-C₁₄ amine oxides commercially available under the trade name Genaminox® LA from Clariant or AROMOX® DMC from AKZO Nobel. Additional suitable nonionic surfactants include polyhydroxy fatty acid amides of the formula:

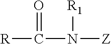

wherein R is a C9-17 alkyl or alkenyl, R1 is a methyl group and Z is glycidyl derived from a reduced sugar or alkoxylated derivative thereof. Examples are N-methyl N-1-deoxyglucityl cocoamide and N-methyl N-1-deoxyglucityl oleamide. Processes for making polyhydroxy fatty acid amides are known and can be found in Wilson, U.S. Pat. No. 2,965,576 and Schwartz, U.S. Pat. No. 2,703,798.

The liquid detergent composition can comprise a zwitterion. The zwitterion can be present at a level of from 0.1 wt % to 5 wt %, preferably from 0.2 wt % to 2 wt %, more preferably from 0.4 wt % to 1 wt %.

Suitable amphoteric or zwitterionic detersive surfactants include those which are known for use in hair care or other personal care cleansing. Non-limiting examples of suitable zwitterionic or amphoteric surfactants are described in U.S. Pat. No. 5,104,646 (Bolich Jr. et al.), U.S. Pat. No. 5,106,609 (Bolich Jr. et al.). Suitable amphoteric detersive surfactants include those surfactants broadly described as derivatives of aliphatic secondary and tertiary amines in which the aliphatic radical can be straight or branched chain and wherein one of the aliphatic substituents contains from 8 to 18 carbon atoms and one contains an anionic group such as carboxy, sulfonate, sulfate, phosphate, or phosphonate. Suitable amphoteric detersive surfactants for use in the present invention include, but are not limited to: cocoamphoacetate, cocoamphodiacetate, lauroamphoacetate, lauroamphodiacetate, and mixtures thereof.

Preferably surfactants comprising saturated alkyl chains are used.

The detergent composition may be in a form selected from the group consisting of a granular detergent, a bar-form detergent, a liquid laundry detergent, a gel detergent, a single-phase or multi-phase unit dose detergent, a detergent contained in a single-phase or multi-phase or multi-compartment water soluble pouch, a liquid hand dishwashing composition, a laundry pretreat product, a multi-compartment non-dissolvable package, a detergent contained on or in a porous substrate or nonwoven sheet, an automatic dish-washing detergent, a hard surface cleaner, a fabric softener composition, and mixtures thereof.

The detergent composition may be incorporated into a fibrous product. The detergent composition may be incorporated into the fibers of a fibrous product, particles within a fibrous product, or a combination thereof.

The detergent composition may have from about 0.1% to about 100% of the carbon content of the first surfactant, the second surfactant, or a combination thereof that is derived from renewable sources. The renewable sources may include natural oils such as coconut, palm kernel and soybean.

The detergent composition may be used in a method of pretreating or treating a soiled fabric comprising contacting the soiled fabric with the detergent composition.

The detergent compositions may comprise an additional surfactant (e.g., a third surfactant, a fourth surfactant) selected from the group consisting of anionic surfactants, nonionic surfactants, cationic surfactants, zwitterionic surfactants, amphoteric surfactants, ampholytic surfactants, and mixtures thereof. The additional surfactant may be a detersive surfactant, which those of ordinary skill in the art will understand to encompass any surfactant or mixture of surfactants that provide cleaning, stain removing, or laundering benefit to soiled material.

The detergent compositions may contain from about 0.01% to about 5% by weight of the detergent composition of an alcohol composition. The detergent compositions may contain from about 0.5% to about 3.0% by weight of the detergent composition of an alcohol composition. At such concentrations, the alcohol compositions may provide a suds suppressing benefit to the detergent composition.

The detergent compositions may contain from about 0.01% to about 0.5% by weight of the detergent composition of an alcohol composition. At such concentrations, the alcohol compositions may be impurities.

Suitable alkyl sulfate anionic surfactants can be made using the process described in WO2021/247801A1, page 9 to 13, line 24. Suitable synthesis examples can be found in WO2021/247801A1, page 13, line 24 to the end of page 18.

### Xyloglucanase

A xyloglucanase is an enzyme having xyloglucanase activity. The term “xyloglucanase activity” is defined herein as an enzyme catalyzed hydrolysis of xyloglucan. The reaction involves endo hydrolysis of 1, 4-beta-D-glucosidic linkages in xyloglucan. For purposes of the present invention, xyloglucanase activity is determined using AZCL-xyloglucan (from Megazyme) as the reaction substrate. The assay can be performed in several ways, e.g. as described in Example 2 of WO2023/165507 or as described in WO 01/62903. One unit of xyloglucanase activity (XyloU) is defined by reference to the assay method described in WO 01/62903, page 60, lines 3-17.

### Sequence Overview

SEQ ID NO: 1 according to WO2023/165507 is a xyloglucanase obtained from Paenibacillus polymyxa.
SEQ ID NO: 2 according to WO2023/165507 is a xyloglucanase obtained from Paenibacillus polymyxa.
SEQ ID NO: 3 according to WO2023/165507 is a xyloglucanase obtained from Paenibacillus polymyxa.
SEQ ID NO: 4 according to WO2023/165507 is a xyloglucanase obtained from Paenibacillus polymyxa.
SEQ ID NO: 5 according to WO2023/165507 is a xyloglucanase obtained from Paenibacillus polymyxa.
SEQ ID NO: 6 according to WO2023/165507 is a xyloglucanase obtained from Paenibacillus polymyxa.
SEQ ID NO: 7 according to WO2023/165507 is a xyloglucanase obtained from Paenibacillus polymyxa.

A xyloglucanase suitable for use in the detergent composition of the invention is preferably a microbial xyloglucanase, such as a bacterial or fungal xyloglucanase.

In an embodiment, the xyloglucanase is obtained from Paenibacillus in particular Paenibacillus polymyxa. In an embodiment, the xyloglucanase comprises the amino acid sequence of SEQ ID NO: 1 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 1.

In an embodiment, the xyloglucanase is obtained from Paenibacillus in particular Paenibacillus polymyxa. In an embodiment, the xyloglucanase comprises the amino acid sequence of SEQ ID NO: 2 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 2.

In an embodiment, the xyloglucanase is obtained from Paenibacillus in particular Paenibacillus polymyxa. In an embodiment, the xyloglucanase comprises the amino acid sequence of SEQ ID NO: 3 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 3.

In an embodiment, the xyloglucanase is obtained from Paenibacillus in particular Paenibacillus polymyxa. In an embodiment, the xyloglucanase comprises the amino acid sequence of SEQ ID NO: 4 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 4.

In an embodiment, the xyloglucanase is obtained from Paenibacillus in particular Paenibacillus polymyxa. In an embodiment, the xyloglucanase comprises the amino acid sequence of SEQ ID NO: 5 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 5.

In an embodiment, the xyloglucanase is obtained from Paenibacillus in particular Paenibacillus polymyxa. In an embodiment, the xyloglucanase comprises the amino acid sequence of SEQ ID NO: 6 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 6.

In an embodiment, the xyloglucanase is obtained from Paenibacillus in particular Paenibacillus polymyxa. In an embodiment, the xyloglucanase comprises the amino acid sequence of SEQ ID NO: 7 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1. In one aspect, the polypeptides differ by up to 10 amino acids, e.g., 1, 2, 3, 4, 5, 6, 7, 8, 9, or 10, from the polypeptide comprising SEQ ID NO: 7.

In an embodiment, the xyloglucanase of SEQ ID NO: 1 or the xyloglucanase of SEQ ID NO: 2, SEQ ID NO: 3, or the xyloglucanase of SEQ ID NO: 4 or the xyloglucanase of SEQ ID NO: 5 or the xyloglucanase of SEQ ID NO: 6 or the xyloglucanase of SEQ ID NO: 7 comprises a substitution, deletion, and/or insertion at one or more (e.g., several) positions. In an embodiment, the number of amino acid substitutions, deletions and/or insertions introduced into the xyloglucanase of SEQ ID NO: 1 or the xyloglucanase of SEQ ID NO: 2, SEQ ID NO: 3, or the xyloglucanase of SEQ ID NO: 4 or the xyloglucanase of SEQ ID NO: 5 or the xyloglucanase of SEQ ID NO: 6, or the xyloglucanase of SEQ ID NO: 7 is not more than 10, e.g., 1, 2, 3, 4, 5, 6, 7, 8 or 9. The amino acid changes may be of a minor nature, that is conservative amino acid substitutions or insertions that do not significantly affect the folding and/or activity of the protein; small deletions, typically of 1-30 amino acids; small amino-or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding domain.

Other suitable xylogucanases for use herein include a yloglucanase variant, comprising an alteration at one or more positions corresponding to positions selected from the group consisting of 111, 123, 159, 256, 294, 8, 18, 20, 41, 42, 76, 82, 83, 87, 94, 103, 104, 105, 121, 125, 126, 127, 136, 137, 146, 147, 148, 152, 153, 155, 165, 168, 169, 177, 184, 189, 203, 206, 210, 211, 214, 217, 219, 220, 226, 237, 238, 240, 243, 244, 248, 251, 252, 267, 271, 276, 289, 295, 298, 300, 302, 322, 329, 339, 347, 347, 353, 383, 384, 392, 394, 395, 402, 414, 427, 431, 445, 447, 459, 473, 474, 476, 482, 488, 489, 491, 492, 503 and 505 of the polypeptide of SEQ ID NO: 1 according to WO2022/043321, wherein the variant has xyloglucanase activity.

The composition of the invention comprises a xyloglucanase, preferably in a level of from 0.0001 to 2%, %, preferably from 0.001 to 0.5% of active enzyme by weight of the detergent composition.

Suitable xyloglucanases are sold under the tradename Whitezyme (Novozymes A/S, Bagsvaerd, Denmark). Examples include Whitezyme 1.ST, Whitezyme 2.0L.

### Perfume

The detergent compositions of the invention may contain perfume. Typically, the composition comprises a perfume that comprises one or more perfume raw materials, selected from the group as described in WO08/87497. However, any perfume useful in a detergent composition, preferably in a laundry care composition may be used.

### Optional Ingredients

The detergent composition may additionally comprise one or more of the following optional ingredients: external structurant or thickener, additional enzymes, enzyme stabilizers, cleaning polymers, bleaching systems, particulate material, odour control agents, hydrotropes, suds suppressors, fabric care benefit agents, pH adjusting agents, dye transfer inhibiting agents, preservatives, non-fabric substantive dyes and mixtures thereof. In more preferred embodiments, the laundry detergent composition does not comprise a bleach.

External structurant or thickener: Preferred external structurants and thickeners are those that do not rely on charge—charge interactions for providing a structuring benefit. As such, particularly preferred external structurants are uncharged external structurants, such as those selected from the group consisting of: non-polymeric crystalline, hydroxyl functional structurants, such as hydrogenated castor oil; microfibrillated cellulose; uncharged hydroxyethyl cellulose; uncharged hydrophobically modified hydroxyethyl cellulose; hydrophobically modified ethoxylated urethanes; hydrophobically modified non-ionic polyols; and mixtures thereof.

Suitable polymeric structurants include naturally derived and/or synthetic polymeric structurants.

Examples of naturally derived polymeric structurants of use in the present invention include: microfibrillated cellulose, hydroxyethyl cellulose, hydrophobically modified hydroxyethyl cellulose, carboxymethyl cellulose, polysaccharide derivatives and mixtures thereof. Non-limiting examples of microfibrillated cellulose are described in WO 2009/101545 A1. Suitable polysaccharide derivatives include: pectine, alginate, arabinogalactan (gum Arabic), carrageenan, gellan gum, xanthan gum, guar gum and mixtures thereof.

Examples of synthetic polymeric structurants or thickeners of use in the present invention include: polycarboxylates, hydrophobically modified ethoxylated urethanes (HEUr), hydrophobically modified non-ionic polyols and mixtures thereof.

Preferably, the aqueous liquid detergent composition has a viscosity of 50 to 5,000, preferably 75 to 1,000, more preferably 100 to 500 mPa·s, when measured at a shear rate of 100 s-1, at a temperature of 20° C. For improved phase stability, and also improved stability of suspended ingredients, the aqueous liquid detergent composition has a viscosity of 50 to 250,000, preferably 5,000 to 125,000, more preferably 10,000 to 35,000 mPa·s, when measured at a shear rate of 0.05 s-1, at a temperature of 20° C.

Cleaning polymers: The detergent composition preferably comprises a cleaning polymer. Such cleaning polymers are believed to at least partially lift the stain from the textile fibres and enable the enzyme system to more effectively break up the complexes comprising mannan and other polysaccharide. Suitable cleaning polymers provide for broad-range soil cleaning of surfaces and fabrics and/or suspension of the soils. Non-limiting examples of suitable cleaning polymers include: amphiphilic alkoxylated grease cleaning polymers; clay soil cleaning polymers; and soil suspending polymers. A preferred cleaning polymer is obtainable by free-radical copolymerization of at least one compound of formula (I),

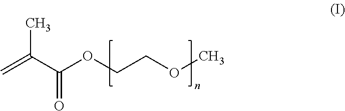

in which n is equal to or greater than 3 for a number,
with at least one compound of formula (II),

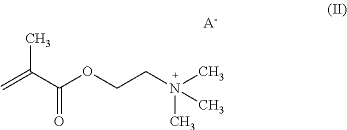

in which A− represents an anion, in particular selected from halides such as fluoride, chloride, bromide, iodide, sulfate, hydrogen sulfate, alkyl sulfate such as methyl sulfate, and mixtures thereof. Such polymers are further described in EP3196283A1.

Other useful cleaning polymers are described in USPN 2009/0124528A1. The detergent composition may comprise amphiphilic alkoxylated grease cleaning polymers, which may have balanced hydrophilic and hydrophobic properties such that they remove grease particles from fabrics and surfaces. The amphiphilic alkoxylated grease cleaning polymers may comprise a core structure and a plurality of alkoxylate groups attached to that core structure. These may comprise alkoxylated polyalkyleneimines, for example. Such compounds may comprise, but are not limited to, ethoxylated polyethyleneimine, ethoxylated hexamethylene diamine, and sulfated versions thereof. Polypropoxylated derivatives may also be included. A wide variety of amines and polyalklyeneimines can be alkoxylated to various degrees. A useful example is 600 g/mol polyethyleneimine core ethoxylated to 20 EO groups per NH and is available from BASF. The alkoxylated polyalkyleneimines may have an inner polyethylene oxide block and an outer polypropylene oxide block. The detergent compositions may comprise from 0.1% to 10%, preferably, from 0.1% to 8%, more preferably from 0.1% to 2%, by weight of the detergent composition, of the cleaning polymer.

Dye transfer inhibitor: The detergent composition can comprise a dye transfer inhibitor. Suitable dye transfer inhibitors can be selected from the group consisting of polyvinylpyrrolidone (PVP), polyvinylimidazole (PVI), copolymers of vinylpyrrolidone and vinylimidazole (PVP/PVI), polyvinyl pyridine-N-oxide, poly-N-carboxymethyl-4-vinylpyridiumchloride, and mixtures thereof, with polyvinylpyrrolidone (PVP), polyvinylimidazole (PVI), copolymers of vinylpyrrolidone and vinylimidazole (PVP/PVI), and mixtures thereof being particularly preferred. The dye transfer inhibitor can be present at a level of from 0.05% to 5%, preferably from 0.1% to 3%, and more preferably from 0.2% to 2.5%, by weight of the detergent composition.

Polymer Deposition Aid: The laundry detergent composition can comprise from 0.1% to 7%, more preferably from 0.2% to 3%, of a polymer deposition aid. As used herein, “polymer deposition aid” refers to any cationic polymer or combination of cationic polymers that significantly enhance deposition of a fabric care benefit agent onto the fabric during laundering. Suitable polymer deposition aids can comprise a cationic polysaccharide and/or a copolymer, with cationic polysaccharide being preferred and polyquaternium 7 being most preferred. “Fabric care benefit agent” as used herein refers to any material that can provide fabric care benefits. Non-limiting examples of fabric care benefit agents include: silicone derivatives, oily sugar derivatives, dispersible polyolefins, polymer latexes, cationic surfactants and combinations thereof. Preferably, the deposition aid is a cationic or amphoteric polymer. The cationic charge density of the polymer preferably ranges from 0.05 milliequivalents/g to 6 milliequivalents/g. The charge density is calculated by dividing the number of net charge per repeating unit by the molecular weight of the repeating unit. In one embodiment, the charge density varies from 0.1 milliequivalents/g to 3 milliequivalents/g. The positive charges could be on the backbone of the polymers or the side chains of polymers.

Organic builder and/or chelant: The laundry detergent composition can comprise from 0.6% to 10%, preferably from 2 to 7% by weight of one or more organic builder and/or chelants. Suitable organic builders and/or chelants are selected from the group consisting of: MEA citrate, citric acid, aminoalkylenepoly(alkylene phosphonates), alkali metal ethane 1-hydroxy disphosphonates, and nitrilotrimethylene, phosphonates, diethylene triamine penta (methylene phosphonic acid) (DTPMP), ethylene diamine tetra(methylene phosphonic acid) (DDTMP), hexamethylene diamine tetra(methylene phosphonic acid), hydroxy-ethylene 1,1 diphosphonic acid (HEDP), hydroxyethane dimethylene phosphonic acid, ethylene di-amine di-succinic acid (EDDS), ethylene diamine tetraacetic acid (EDTA), hydroxyethylethylenediamine triacetate (HEDTA), nitrilotriacetate (NTA), methylglycinediacetate (MGDA), iminodisuccinate (IDS), hydroxyethyliminodisuccinate (HIDS), hydroxyethyliminodiacetate (HEIDA), glycine diacetate (GLDA), diethylene triamine pentaacetic acid (DTPA), catechol sulfonates such as TironTM and mixtures thereof.

### Other Enzymes

The detergent composition may comprise other enzymes in addition to the xylogluconase. Suitable enzymes provide cleaning performance and/or fabric care benefits. Examples of other suitable enzymes include, but are not limited to amylase, peroxidases, proteases, xylanases, lipases, cellulases, phospholipases, esterases, cutinases, pectinases, keratanases, reductases, oxidases, phenoloxidases, lipoxygenases, ligninases, pullulanases, tannases, pentosanases, malanases, B-glucanases, arabinosidases, hyaluronidase, chondroitinase, laccase, and known amylases, or combinations thereof. A preferred enzyme system further comprises a cocktail of conventional detersive enzymes such as amylase, protease, lipase and/or cutinase. Detersive enzymes are described in greater detail in U.S. Pat. No. 6,579,839.

Enzyme stabiliser: Enzymes can be stabilized using any known stabilizer system such as calcium and/or magnesium compounds, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly hexa methylene bi guanide or N,N-bis-3-amino-propyl-dodecyl amine or salt; and mixtures thereof.

Hydrotrope: The detergent composition may comprise, based on the total detergent composition weight, from 0 to 30%, preferably from 0.5 to 5%, more preferably from 1.0 to 3.0%, which can prevent liquid crystal formation. The addition of the hydrotrope thus aids the clarity/transparency of the composition. Suitable hydrotropes comprise but are not limited to urea, salts of benzene sulphonate, toluene sulphonate, xylene sulphonate or cumene sulphonate. Preferably, the hydrotrope is selected from the group consisting of propylene glycol, xylene sulfonate, ethanol, and urea to provide optimum performance.

Particles: The composition can also comprise particles, especially when the composition further comprises a structurant or thickener. The composition may comprise, based on the total composition weight, from 0.02% to 10%, preferably from 0.1% to 4%, more preferably from 0.25% to 2.5% of particles. Said particles include beads, pearlescent agents, microcapsules, and mixtures thereof.

Microcapsules: Suitable capsules are typically formed by at least partially, preferably fully, surrounding a benefit agent with a wall material. Preferably, the capsule is a perfume capsule, wherein said benefit agent comprises one or more perfume raw materials. The capsule wall material may comprise: melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, resorcinol-based materials, poly-isocyanate-based materials, acetals (such as 1,3,5-triol-benzene-gluteraldehyde and 1,3,5-triol-benzene melamine), starch, cellulose acetate phthalate and mixtures thereof. Preferably, the capsule wall comprises melamine and/or a polyacrylate based material. The perfume capsule may be coated with a deposition aid, a cationic polymer, a non-ionic polymer, an anionic polymer, or mixtures thereof. Preferably, the perfume capsules have a volume weighted mean particle size from 0.1 microns to 100 microns, preferably from 0.5 microns to 60 microns. Especially where the composition comprises capsules having a shell formed at least partially from formaldehyde, the composition can additionally comprise one or more formaldehyde scavengers.

### Process of Making the Laundry Detergent Composition:

The detergent compositions can be made using any suitable process known to the skilled person. Typically, the ingredients are blended together in any suitable order. Preferably, the detersive surfactants are added as part of a concentrated premix, to which are added the other optional ingredients. Preferably, the solvent is added either last, or if an external structurant is added, immediately before the external structurant, with the external structurant being added as the last ingredient.

### Method of Laundering Fabrics:

The detergent compositions of the present invention can be used to launder fabrics. In such methods, the laundry detergent composition is diluted to provide a wash liquor having a total surfactant concentration of greater than 300 ppm, preferably from 400 ppm to 2,500 ppm, more preferably from 600 ppm to 1000 ppm. The fabric is then washed in the wash liquor, and preferably rinsed.

### Methods

### A) pH Measurement:

The pH is measured, at 25° C., using a Santarius PT-10P pH meter with gel-filled probe (such as the Toledo probe, part number 52 000 100), calibrated according to the instructions manual. The pH is measured in a 10% dilution in demineralised water (i.e. 1 part laundry detergent composition and 9 parts demineralised water).

### B) Method of Measuring Viscosity:

The viscosity is measured using an AR 2000 rheometer from TA instruments using a cone and plate geometry with a 40 mm diameter and an angle of 1°. The viscosity at the different shear rates is measured via a logarithmic shear rate sweep from 0.1 s-1 to 1200 s-1 in 3 minutes time at 20D C. Low shear viscosity is measured at a continuous shear rate of 0.05 s-1.

### Examples

White fabrics were washed in presence of soil using laundry detergent compositions comprising: i) a xyloglucanase and no hueing dye; ii) hueing dye and no xyloglucanase; iii) a xyloglucanase and a hueing dye.

### Fabric Whiteness Analysis

The method used analyzes the ability of detergent to keep white items from whiteness loss when they are washed in the presence of soil. The formulations were used to wash 8″×8″ white cotton terry (CT), cotton knit (CK), polyester/cotton (PC) supplied by WFK Testgewebe GmbH, Christenfeld 10, D-41379 Brüggen, Deutschland. 2.14 grams/liter of each liquid detergent formulation was added to 7.57-liter pot filled with 7 grains/gallon hardness at constant 77 degrees Fahrenheit and allowed to agitate at 80 strokes per minute for 45 seconds.

Eight artificial soil, SBL2004 soil sheets supplied by WFK, were added to each of the 5 automatic mini-washer pots for background soil. The soil sheets were agitated for an additional 2 minutes prior to the addition of the white test fabric. Four internal replicate Cotton Terry, Cotton Knit, Polycotton fabrics were added to each pot. Fabrics were agitated with detergent and soil for 18 minutes. Each pot was drained, and fabrics were spun dry. The SBL soil sheets were removed, and rinse water was added with 7 grains/gallon hardness at constant 59 degrees Fahrenheit. Each pot agitated for an additional 3 minutes for the rinse cycle before they were drained.

All white test fabrics were placed in tumble dryer set on high until for 45 min and spun dry. After the dry cycle, the method was repeated 2 additional times. On the third cycle, the average whiteness was reported for each white test fabric using instrumental readings on a Konica-Minolta Spectrophotometer.

The results in table 1-3 show the whiteness advantage when combining Whitezyme 2.0 and V200 (delta=washed vs unwashed) versus the expected independently additive benefit using Whitezyme 2.0 or V200. Composition A is used as reference. Table 4 contains the compositions for Formulas A-D.

TABLE 1
Cotton Terry

| | 0.003% | 0.04% | Expected | 0.003% | |
|---|---|---|---|---|---|
| Cotton Terry | Whitezyme | V200 | Result | Whitezyme 2.0 + | Synergy |
| Fabric | 2.0 (B) | (C) | (B) + (C) | 0.04% V200 (D) | (D > B + C) |
| Delta CIE WI vs | 7.90 | 2.05 | 9.95 | 12.06 | 21% more than |
| reference (A) | | | | | expected |

TABLE 2
Cotton Knit

| | 0.003% | 0.04% | Expected | 0.003% | |
|---|---|---|---|---|---|
| Cotton Knit | Whitezyme | V200 | Result | Whitezyme 2.0 + | Synergy |
| Fabric | 2.0 (B) | (C) | (B) + (C) | 0.04% V200 (D) | (D > B + C) |
| Delta CIE WI vs | 7.50 | 1.43 | 8.93 | 9.26 | 3.7% more than |
| reference (A) | | | | | expected |

TABLE 3
Polycotton

| | | | | 0.003% | |
|---|---|---|---|---|---|
| | 0.003% | 0.04% | Expected | Whitezyme | |
| Polycotton | Whitezyme | V200 | Result | 2.0 + 0.04% | Synergy |
| Fabric | 2.0 (B) | (C) | (B) + (C) | V200 (D) | (D > B + C) |
| Delta CIE WI vs | 0.11 | −1.62 | −1.51 | 1.91 | 227% more than |
| reference (A) | | | | | expected |

TABLE 4
Formulation Composition (raw materials expressed
as % active by weight of the composition)

| | Composition A | Composition B | Composition C | Composition D |
|---|---|---|---|---|
| Whitezyme 2.0¹ | — | 0.003 | — | 0.003 |
| V200² | — | — | 0.04 | 0.04 |
| SLS³ | 3.466 | 3.466 | 3.466 | 3.466 |
| AES⁴ | 2.072 | 2.072 | 2.072 | 2.072 |
| HLAS⁵ | 10.712 | 10.712 | 10.712 | 10.712 |
| NI⁶ | 12.001 | 12.001 | 12.001 | 12.001 |
| Amine Oxide⁷ | 0.358 | 0.358 | 0.358 | 0.358 |
| Chelant⁸ | 0.260 | 0.260 | 0.260 | 0.260 |
| Citric acid⁹ | 0.652 | 0.652 | 0.652 | 0.652 |
| Protease¹⁰ | 0.08 | 0.08 | 0.08 | 0.08 |
| Mannanase¹¹ | 0.001 | 0.001 | 0.001 | 0.001 |
| Amylase¹² | 0.013 | 0.013 | 0.013 | 0.013 |
| Ethoxylated | 0.624 | 0.624 | 0.624 | 0.624 |
| polyethyleneimine¹³ | | | | |
| PEI600 E024 PO16 ¹⁴ | 1.50 | 1.50 | 1.50 | 1.50 |

¹Whitezyme 2.0 commercially available from Novozyme
²Liquitint ® Violet 200, hueing dye premix from Milliken
³C12/C14 Alkyl Sulfate sourced from P&G Chemicals
⁴C12-15EO2.5S AlkylethoxySulfate where the alkyl portion of AES includes from about 13.9 to 14.6 carbon atoms
⁵Linear Alkyl Benzene Sulfonate sourced from P&G Chemicals
⁶Surfonic L24-9 commercially available from Huntsman and Neodol 45-7 commercially available from Shell Chemicals
⁷Natural C12/14 Amine Oxide available from P&G Chemicals
⁸Chelant is DISSOLVINE GL-47-S commercially available from AkzoNobel
⁹Citrosol 502 commercially available from Archer Daniels Midland
¹⁰Protease commercially available from IFF
¹¹Mannanase commercially available from Novozymes
¹²Amylase commercially available from Novozymes
¹³Ethoxylated polyethyleneimine commercially available from BASF
¹⁴ PEI600 E024 PO16 commercially available from BASF

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry detergent composition comprising:
a) from about 0.0001% to about 1% by weight of the composition of a hueing dye;
b) a xyloglucanase; and
wherein the composition is substantially free of optical brightener.

2. The detergent composition according to claim 1, wherein the hueing dye is selected from the group consisting of small molecule dyes and polymeric dyes.

3. The detergent composition according to claim 1, wherein the hueing dye comprises a polymeric azo polyoxyalkylene dye.

4. The detergent composition according to claim 1, wherein the hueing dye comprises a polymeric dye of Formula A: 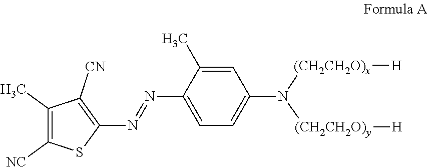
wherein the index values x and y are independently selected from 1 to 10.

5. The detergent composition according to claim 1 wherein the xyloglucanase has an amino acid sequence selected from the group consisting of SEQ ID NO: 1, SEQ ID NO: 2, SEQ ID NO: 3, SEQ ID NO: 4, SEQ ID NO: 5, SEQ ID NO: 6 and SEQ ID NO: 7, or a xyloglucanase that has an amino acid sequence having at least 60%, at least 65%, at least 70%, at least 75%, at least 80%, at least 85%, at least 90%, at least 95%, at least 96%, at least 97%, at least 98%, at least 99% or at least 100% sequence identity to any of SEQ ID NO: 1, SEQ ID NO: 2, SEQ ID NO: 3, SEQ ID NO: 4, SEQ ID NO: 5, SEQ ID NO: 6 and SEQ ID NO: 7.

6. The detergent composition according to claim 1, wherein said detergent composition is a form selected from the group consisting of a granular detergent, a bar-form detergent, a liquid laundry detergent, a gel detergent, a single-phase or multi-phase unit dose detergent, a detergent contained in a single-phase or multi-phase or multi-compartment water soluble pouch, a multi-compartment non-dissolvable package, a liquid hand dishwashing composition, a laundry pretreat product, a detergent contained on or in a porous substrate or nonwoven sheet, a water soluble fibrous product, and mixtures thereof.

7. The detergent composition according to claim 1, wherein the composition is a liquid composition.

8. The detergent composition according to claim 1, wherein the composition has a pH of from about 7.5 to about 9.5.

9. The detergent composition according to claim 1, wherein the composition comprises from about 10% to about 50% by weight of the composition of surfactant.

10. The detergent composition according to claim 1, wherein the composition comprises a surfactant selected from the group consisting of non-ionic surfactant, alkyl benzene sulfonates, alkoxylated alkyl sulfates, alkyl sulfates, and mixtures thereof.

11. The detergent composition according to claim 1 comprising a non-ionic surfactant wherein the non-ionic is derived from natural sources.

12. The detergent composition according to claim 1, wherein the composition comprises from about 0.01% to less than about 3% by weight of the composition of an alkoxylated alkyl sulfate surfactant.

13. The detergent composition according to claim 1, wherein the composition comprises an amylase and a protease.

14. The detergent composition according to claim 1, wherein the composition comprises a mannanase.

15. The detergent composition according to claim 1, wherein the composition is substantially free of borate.

16. A method of laundering fabric wherein the method comprises the steps of:
a) providing a detergent composition according to claim 1;
b) diluting the detergent composition to provide a wash liquor having a total surfactant concentration of greater than about 100 ppm; and
c) washing fabric in the wash liquor.

17. Use of a detergent composition according to claim 1 for the laundering of white fabric in presence of soil to prevent whiteness loss.
